(19) United States
(12) Patent Application Publication
(10) Pub. No.: US 2012/0143791 A1
(43) Pub. Date: Jun. 7, 2012

(54) METHOD AND APPARATUS FOR CAUSING AN APPLICATION RECOMMENDATION TO ISSUE

(75) Inventor: Sailesh Sathish, Tampere (FI)

(73) Assignee: Nokia Corporation

(21) Appl. No.: 12/958,764

(22) Filed: Dec. 2, 2010

(51) Int. Cl. G06F 15/18

(52) U.S. Cl. 706/12

(57) ABSTRACT

An apparatus may include a monitoring module configured to monitor user interactions by a user with applications. A contextual characteristics determiner may determine one or more contextual characteristics relating to the user interactions. Thereby, a data model builder may build a user behavior model for the user based at least in part on the user interactions and the contextual characteristics. The apparatus may provide for private storage of the user behavior module. A recommendation module may issue a recommendation, which may be mapped to one of the applications, based at least in part on the user behavior model. The recommendation may be issued in response to a query directed to a query module. The query may include current contextual characteristics of the user and/or the apparatus. The application recommendation may include one or more applications selected from one or more content providers, as controlled by a registrar module.

### TECHNOLOGICAL FIELD

An example embodiment of the present invention relates generally to techniques for causing an application recommendation to be issued and, more particularly, relates to an apparatus, a method and a computer program product for causing an application recommendation to issue for the user based at least in part on a user behavior model and the one or more device characteristics.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels may utilize mobile terminals to communicate with other individuals or contacts, receive services and/or share information, media and other content.

Some of the technologies which are becoming more popular are those of location based services and other personalized services. In this regard, some technologies may provide users of properly equipped mobile terminals with content that is specific to the present location of the user. Thus, for example, the user may be provided with weather information relating to the user's present location. Thereby, content may be provided to the user which may be relevant to the user's interests and current context. However, privacy of user information may be an issue and interests of users may be difficult to determine. Further, content that is relevant to the user's interests and current context may not necessarily be compatible with the user's mobile terminal.

### BRIEF SUMMARY

A method, apparatus and computer program product are therefore provided that may build a user behavior model, determine device characteristics, and issue application recommendations while maintaining control over user information.

In an example embodiment, an apparatus comprises at least one processor and at least one memory including computer program code, the at least one memory and the computer program code configured to, with the processor, cause the apparatus to determine one or more device characteristics. Further, the apparatus may determine one or more contextual characteristics relating to one or more user interactions by a user. Thereby, the apparatus may build a user behavior model for the user based at least in part on the user interactions and the contextual characteristics. Additionally, the apparatus may be configured to cause an application recommendation to issue for the user based at least in part on the user behavior model and the one or more device characteristics.

In an additional example embodiment a method comprises determining one or more device characteristics. The method may further include determining one or more contextual characteristics via a processor relating to one or more user interactions by a user. Thereby, the method may also include building a user behavior model for the user based at least in part on the user interactions and the contextual characteristics. Additionally, the method may include causing an application recommendation to issue for the user based at least in part on the user behavior model and the one or more device characteristics.

In a further example embodiment a computer program product comprises at least one computer-readable storage medium having computer-executable program code portions stored therein, the computer-executable program code portions comprising program code instructions for determining one or more device characteristics. Further, the computer program product may comprise program code instructions for determining one or more contextual characteristics relating to one or more user interactions by a user. Thereby, the computer program product may also include program code instructions for building a user behavior model for the user based at least in part on the user interactions and the contextual characteristics. Additionally, the computer program product may comprise program code instructions for causing an application recommendation to issue for the user based at least in part on the user behavior model and the one or more device characteristics.

In a further example embodiment an apparatus comprises means for determining one or more device characteristics. The apparatus may further include means for determining one or more contextual characteristics relating to one or more user interactions by a user. Thereby, the apparatus may also include means for building a user behavior model for the user based at least in part on the user interactions and the contextual characteristics. Additionally, the apparatus may include means for causing an application recommendation to issue for the user based at least in part on the user behavior model and the one or more device characteristics.

In some embodiments the application recommendation may be issued based at least in part on one or more current contextual characteristics. Also, the contextual characteristics may be categorized based on an ontology model. Further, the one or more device characteristics may comprise at least one of a hardware indicator and a software indicator. In some embodiments the user behavior model may be privately stored. Additionally, issuing the recommendation may occur by selecting one or more applications supplied by a plurality of content providers. Registration of the content providers from which the one or more applications are selected may be controlled.

User interface circuitry may also be provided which is configured to facilitate user control of at least some functions through use of a display. The user interface circuitry may cause at least a portion of a user interface to be displayed on the display to facilitate user control of at least some functions. Accordingly, embodiments of the present invention may provide a way to build user behavior models based on user interactions with applications and related contextual characteristics. Further, device characteristics may be determined. Thus, application recommendations may be improved so as to relate to the user's interests and device capabilities while also maintaining privacy.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus configured to cause an application recommendation to issue for a user according to an example embodiment of the present invention;

FIG. 3 illustrates a schematic block diagram of an embodiment of the apparatus of FIG. 2 including additional components configured cause an application recommendation to issue for a user according to an example embodiment of the present invention; and

FIG. 4 illustrates a flowchart of the operations performed in causing an application recommendation to issue for a user according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a computer-readable storage medium, which refers to a non-transitory, physical storage medium (e.g., volatile or non-volatile memory device), can be differentiated from a computer-readable transmission medium, which refers to an electromagnetic signal.

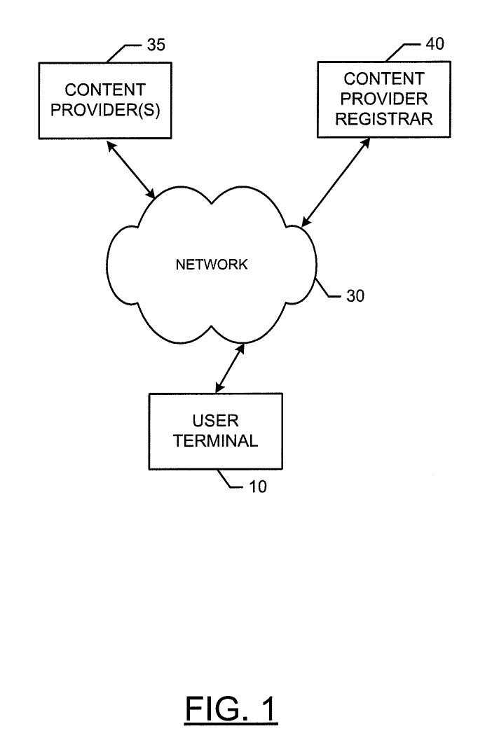

As indicated above, some embodiments of the present invention may be employed in methods, apparatuses and computer program products configured to cause an application recommendation to issue for a user. In this regard, for example, FIG. 1 illustrates a block diagram of a system that may benefit from embodiments of the present invention. It should be understood, however, that the system as illustrated and hereinafter described is merely illustrative of one system that may benefit from an example embodiment of the present invention and, therefore, should not be taken to limit the scope of embodiments of the present invention.

As shown in FIG. 1, a system in accordance with an example embodiment of the present invention may include a user terminal 10. The user terminal 10 may be any of multiple types of fixed or mobile communication and/or computing devices such as, for example, personal digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, which employ an embodiment of the present invention.

In some embodiments the user terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal and/or the other devices may be enabled to communicate with each other, for example, according to numerous communication protocols including Hypertext Transfer Protocol (HTTP) and/or the like, to thereby carry out various communication or other functions of the user terminal and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The user terminal 10 may be configured to execute applications and thereby output text, pictures, data, audio, video, and/or various other embodiments of content. The users may also employ the applications to perform various functions such as, for example, a calculator function. Thereby, users may employ the user terminal 10 to interact with various types of content and perform various functions through execution of one or more applications.

In some embodiments the applications may be provided to the user terminal 10 by one or more content providers 35. In some embodiments each of the content providers 35 may be embodied as a server, server bank or other computer or other computing device or node configured to provide applications to the user terminal 10. Each of the content providers 35 may have any number of functions or associations with various services. As such, for example, each of the content providers 35 may be a platform such as a dedicated server (or server bank), or each of the content providers may be a backend server associated with one or more other functions or services. In some embodiments one or more of the content providers 35 may comprise application “stores” which sell or otherwise provide a variety of different applications from a plurality of entities that create the applications (e.g., developers). Further, in some embodiments one or more of the content providers 35 may comprise an entity (e.g., a developer) that creates and sells or gives away its own applications, or a limited number of applications. Thus, the content providers 35 may provide various applications to the user terminal 10 for use by a user thereof.

In some embodiments the system may further comprise a content provider registrar 40. In some embodiments the content provider registrar 40 may be embodied as a server, server bank or other computer or other computing device or node configured to control registration of the content providers 35 from which the one or more applications are selected for use by the user terminal 10. Thus, in some embodiments the content provider registrar 40 may selectively allow or disallow the content providers 35 from providing applications to the user terminal 10 by allowing or disallowing registration of the content providers as potential application sources. In particular, the user terminal 10 may be configured to issue application recommendations, and in some embodiments the application recommendations may only include applications provided by the content providers 35 that are registered with the content provider registrar 40. Further, the content provider registrar may store application profile information relating to the characteristics of the applications that are registered, or it may provide this information to the user terminal 10 for storage on the user terminal.

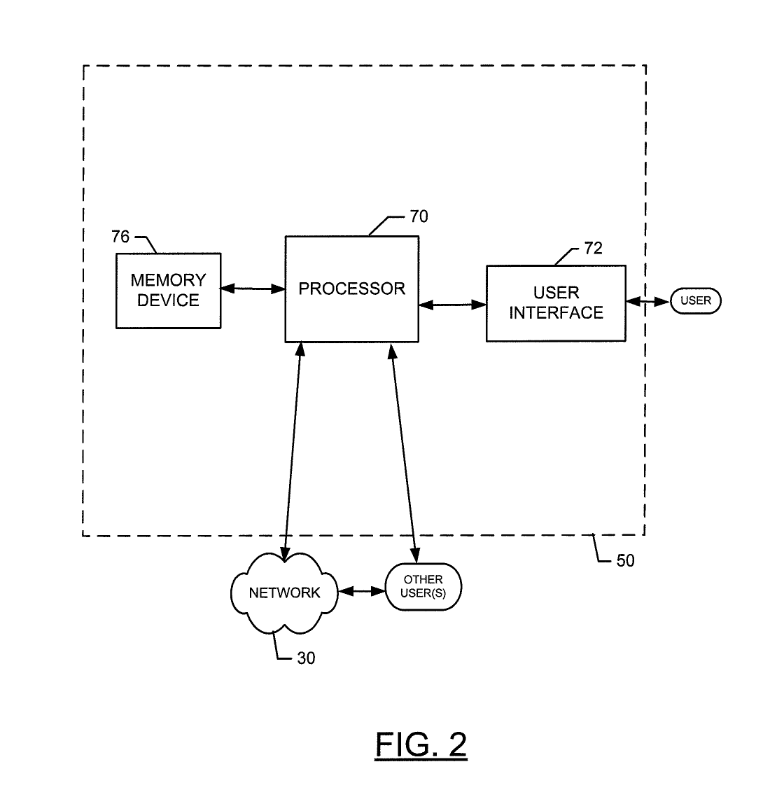

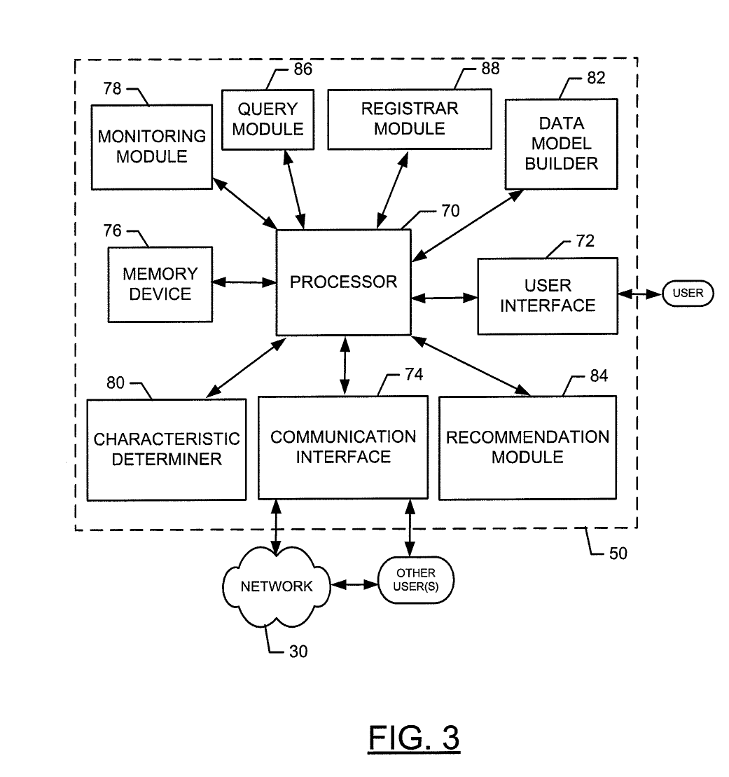

In example embodiments illustrated in FIGS. 2 and 3, an apparatus 50 is provided that may be employed by devices performing example embodiments of the present invention. The apparatus 50 may be embodied, for example, as any device hosting, including, controlling, comprising, or otherwise forming a portion of the user terminal 10, the content providers 35, and/or the content provider registrar 40. However, embodiments may also be embodied on a plurality of other devices such as for example where instances of the apparatus 50 may be embodied on the network 30. As such, the apparatus 50 of FIGS. 2 and 3 is merely an example and may include more, or in some cases less, than the components shown in FIGS. 2 and 3.

With further regard to FIGS. 2 and 3, the apparatus 50 may be configured to cause an application recommendation to issue for a user. As depicted in FIG. 2, the apparatus 50 may include or otherwise be in communication with a processor 70, a user interface 72, and a memory device 76. The memory device 76 may include non-transitory and tangible memory that may be, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70.

As mentioned above, the apparatus 50 may, in some embodiments, be a user terminal or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or other hardware processor. In an example embodiment, the processor 70 may be configured to execute instructions stored in the memory device 76 or otherwise accessible to the processor. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor to perform the algorithms and/or operations described herein when the instructions are executed. However, in some cases, the processor 70 may be a processor of a specific device (for example, a user terminal or network device such as a server) adapted for employing embodiments of the present invention by further configuration of the processor by instructions for performing the algorithms and/or operations described herein. The processor 70 may include, among other things, a clock, an arithmetic logic unit (ALU) and logic gates configured to support operation of the processor.

The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, or other input/output mechanisms.

The processor 70 may comprise user interface circuitry configured to control at least some functions of one or more elements of the user interface 72, such as, for example, the speaker, the ringer, the microphone, the display, and/or the like. The processor 70 and/or user interface circuitry comprising the processor 70 may be configured to control one or more functions of one or more elements of the user interface 72 through computer program instructions (for example, software and/or firmware) stored on a memory accessible to the processor 70 (for example, memory device 76, and/or the like).

As mentioned above, embodiments of the apparatus 50 may include more, or in some cases less, than the components shown in FIG. 2. In this regard, FIG. 3 illustrates an embodiment of the apparatus 50 comprising additional components configured to cause an application recommendation to issue for a user. The apparatus 50 may include or otherwise be in communication with the processor 70, the user interface 72, and the memory device 76 as described above with respect to FIG. 2. Note that a module, as may be used herein, need not necessarily be modularized, but instead may be distributed in some embodiments. Thus, the term module is only used to designate the functions associated with or performed by the respective module.

In some embodiments the apparatus 50 may further comprise a communication interface 74. The communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

In some embodiments the apparatus 50 may further include a monitoring module 78. The processor 70 or other circuitry may be embodied as, include or otherwise control the monitoring module 78. The monitoring module 78 may be configured to monitor one or more user interactions by a user. For example, the monitoring module 78 may monitor user interactions by a user with one or more applications. The context under which the user interactions take place may also be monitored. For example, the monitoring module 78 may monitor the context, or the context may be determined by a separate module and provided thereto by a separate module, as will be discussed below. The monitoring module 78 may thereby provide for storage of user interaction data (e.g., in the memory device 76).

In one embodiment, monitoring user interactions with the applications may include monitoring user interactions that open and close applications. Thus, in one embodiment the monitoring module 78 may monitor application usage by the user by tracking instances in which the user opens and closes the applications. However, in other embodiments the monitoring module 78 may monitor other user interactions with the applications. For example, the monitoring module 78 may monitor user interactions with various functions provided within the applications. Further, the monitoring module 78 may in some embodiments also monitor user interactions with content provided to the user by applications. For example, the monitoring module 78 may monitor selection and viewing of content. As noted above, context relating to the various user interactions may also be determined.

Thus, user interactions, as used herein, may refer to user inputs, or other interaction with the applications and/or content provided by the applications. User interactions may include standard document object model (DOM) events obtained through user interaction with a web page, though they are not limited thereto. Thus, for example, when a user clicks on a function within an application or selects content within the application, the monitoring module 78 may monitor this activity in some embodiments. Conversely, user interactions may also comprise the lack of a user action. For example, if a user does not open an application or the user does not click on or otherwise interact with content provided by an application, the monitoring module 78 may monitor this lack of activity. However, as noted above, in some embodiments the monitoring module 78 may monitor more or less user interactions. For example, in one embodiment the monitoring module 78 may monitor user interactions that open and close applications, and the names (or other identifiers) of the applications which are opened and closed. Thus, in some embodiments the monitoring module 78 may record application usage data.

In embodiments in which user interactions within the applications are monitored, as opposed to only monitoring opening and closing of applications and the names (or other identifiers) thereof, the applications may be configured to provide data relating to the user interactions to the monitoring module 78. For example, the applications may be initially programmed to provide data relating to the user interactions to the monitoring module 78. Alternatively, the monitoring module 78 may be configured to insert a script into the applications (or content provided therewith) that provides the user interaction data to the monitoring module. However, in embodiments that only monitor user interactions that open and close the applications, and the names (or other identifiers) of the applications, customization of the applications or insertion of a script may not be required. Further, in some embodiments, data communications to, from, and/or between applications may be monitored with user permission that may not require changes to the application. For example, the communications may be interpreted appropriately through knowledge of which applications are communicating.

In some embodiments the apparatus 50 may further include a characteristic determiner 80. The processor 70 or other circuitry may be embodied as, include or otherwise control the characteristic determiner 80. The characteristic determiner 80 may be configured to determine one or more contextual characteristics and/or one or more device characteristics.

In some embodiments the characteristic determiner 80 may be configured to determine contextual characteristics relating one or more user interactions by a user. For example, the characteristic determiner 80 may be configured to determine contextual characteristics of the apparatus 50 and/or the user at the time of the user interactions which are monitored by the monitoring module 78. Contextual characteristics may include the present time, location, activity, age, etc. of the user and/or the apparatus 50. Information relating to the location of the user may, for example, be provided by a GPS module, though location information may additionally or alternatively be provided through other means such as triangulation using cell phone towers in some embodiments.

In some embodiments the characteristic determiner 80 may be configured to categorize the contextual characteristics that are determined. For example, the characteristic determiner 80 may determine that the time at which a user opened an application is 8:30 AM. The characteristic determiner 80 may thus categorize this contextual characteristic into the category of “morning.” By way of further example, the characteristic determiner 80 may determine that the user was at a specific location at the time of opening the application. The characteristic determiner 80 may categorize the location if it corresponds to known locations of significance, such as home, work, a child's school, etcetera. Further, if the characteristic determiner 80 determines that the user is moving, the mode of transportation, such as walking, biking, in a car, on a train, etcetera may be categorized based on determined speed, road and rail maps, and/or other information. Accordingly, in some embodiments the contextual characteristics may be compartmentalized into certain categories, and hence the contextual characteristics may be potentially more useful for building a user behavior model, as will be discussed below. In some embodiments the categories may be based on an ontology model such that standardized terminology may be employed for the contextual characteristics.

The characteristic determiner 80 may be further configured to determine one or more device characteristics. In some embodiments the characteristic determiner 80 may create a dynamic device profile comprising the device characteristics. Device characteristics may comprise hardware indicators and software indicators in some embodiments. Hardware indicators may comprise data and information relating to the hardware installed on the device (e.g. the apparatus 50), or which may be installed thereon. For example, hardware indicators may describe the types, specifications, and configurations of hardware that is included with the device. Thereby, for example, the processor speed may be known, the type of input device may be known, the amount of memory available may be known, whether or not the device includes a camera or GPS module may be known, and/or etcetera. Thus, hardware indicators may describe, for example, the presence or absence of various hardware components as well as specifications relating thereto.

Further, software indicators may comprise data and information relating to the type of software that is installed on the device (e.g. the apparatus 50), or which may be installed thereon. Software indicators, as used herein, include information relating to firmware. Thereby, for example, the software indicators may describe the type and version of the operating system as well as other indicators of the platform operating on the device and the types of software that may run thereon.

Thus, the device characteristics may comprise contextual characteristics relating to the apparatus 50. Determination of device characteristics by the characteristic determiner 80 may provide information with regard to what applications are compatible with the apparatus 50. For example, some applications may only be compatible with certain operating systems, user input devices, etcetera. By way of further example, a video chat application may only function when the apparatus 50 comprises a video capturing device. Accordingly, the characteristic determiner 80 may determine the device characteristics of the apparatus 50, and thereby the capabilities thereof may be known.

In some embodiments the apparatus 50 may further include a data model builder 82. The processor 70 or other circuitry may be embodied as, include or otherwise control the data model builder 82. The data model builder 82 may be configured to build a user behavior model for the user based at least in part on the user interactions and the contextual characteristics. Building a user behavior model may include starting a new user behavior model, populating a user behavior model, and/or modifying a user behavior model in some embodiments. As will be discussed below, the user behavior model may be employed in issuing application recommendations for the user.

In some embodiments the data model builder 82 may build the user behavior model in the form of a matrix. For example, the user behavior model may comprise a matrix factorization model. The matrix may comprise user interaction data as one vector, which may be provided by the monitoring module 78, as described above. Further, the matrix may comprise contextual characteristics as another vector, which may be provided by the characteristic determiner 80, as described above. Thus, for example, in one embodiment the matrix may comprise user interaction data indicating application usage for each application (e.g., the user interaction vector) and corresponding contextual characteristics (e.g., the contextual characteristics vector) which are determined to exist at the time of the user interactions. Accordingly, the user behavior model built by the data model builder 82 may reflect user preference for the user of the apparatus 50 by compiling data on past apparatus usage by the user. In particular, the user behavior model may relate to application usage by the user in some embodiments.

The data model builder 82 may start with a relatively sparsely populated matrix (or a completely unpopulated matrix). However, over time the matrix may populate as user interaction data and associated contextual characteristics are provided to the data model builder by, for example, the monitoring module 78 and the characteristic determiner 80. Further, in some embodiments the data model builder 82 may completely fill the matrix. For example, where entries for actual user interactions and contextual characteristics are not recorded, the data model builder 82 may make entries based on predictions from adjacent entries or other fields that have observed values such as user behavior under other context combinations. In some embodiments, other user models may be used to predict missing data in the current user model. This may be a continuous process whereby monitored data may be fed to the data model builder 82 and thereby the data model builder may attempt to reduce the prediction error by updating the model with monitored data. Accordingly, the data model builder 82 may build a user behavior model relatively more quickly than otherwise may occur, and further the user behavior model may become more accurate over the course of time.

Note that as used herein, the term “user” refers to a single person, or a single device. Thus, for example, in one embodiment the data model builder 82 may build a user behavior model relating to user interactions by all persons using the apparatus 50. However, in other embodiments the data model builder 82 may build a user behavior model relating to user interactions for a single person. For example, the apparatus 50 may request or require that each person login so that the identity of the person interacting with apparatus is known and thereby the user behavior model may relate only to that person. Further, in embodiments in which the user interactions are recorded for single persons, this information may be, for example, stored in one dataset for all of the persons. However, the dataset may be separable based on the identities of the persons such that unique user behavior models may be provided for each person in some embodiments. In some embodiments missing data in the user behavior model may be retrieved from other user behavior models if users are found to be similar. Alternatively, separate datasets may be used for each user behavior model when user behavior models are recorded for multiple people.

The user behavior model built by the data model builder 82 may be privately stored. For example, the user behavior model may be stored in the memory device 76 or other local memory. Alternatively, the user behavior model may be stored remotely, but still remain privately stored. For example, the remotely stored user behavior model may only be accessible by the user. Thereby, the information in the user behavior model may remain private.

In some embodiments the apparatus 50 may further include a recommendation module 84. The processor 70 or other circuitry may be embodied as, include or otherwise control the recommendation module 84. The recommendation module 84 may be configured to issue a recommendation based at least in part on the user behavior model and the one or more device characteristics.

In an example embodiment the recommendation module 84 may cause an application recommendation to issue that is generically based on the user behavior model and the one or more device characteristics, and thus does not take into account current contextual characteristics. However, in other embodiments the recommendation module 84 may additionally or alternatively base the recommendation on current contextual characteristics of the apparatus 50 and/or the user of the apparatus, as may be determined by the characteristic determiner 80. Thereby, the recommendation module may determine which applications have been used under previously recorded contextual characteristics that are similar to the current contextual characteristics.

Thus, in one embodiment the recommendation module 84 may search the user behavior model (e.g., by searching the contextual characteristic vector) for contextual characteristics that are similar to current contextual characteristics, and then recommend one or more applications based on the profiles of the previously used applications (e.g., from the user interaction vector) that have been used under similar circumstances (as reflected by the contextual characteristics) or by a prediction in the user behavior model made by the data model builder 82. Thereby, the recommendation module 84 may cause the application recommendation to issue based at least in part on one or more current contextual characteristics in some embodiments. In some embodiments the recommendation module 84 may provide the user with a list of available applications from which to make a selection. However, in other embodiments the recommendation module 84 may cause the application recommendation to issue in the form of a single application. The recommendation module 84 may alternatively or additionally recommend content for output and/or functions for performance by the application in some embodiments depending on what user interaction data has been recorded in the user behavior model.

The one or more applications that are recommended may be selected from previously used applications, as well as from applications that have not been used previously in some embodiments. In this regard, causing the application recommendation to issue may be further based at least in part on the one or more device characteristics, as mentioned above, and application profile information provided during registration of applications that can be compared against application profile information of the applications that have been previously used and hence appear in the user behavior model. Thereby, the recommendation module 84 may be configured to select one or more applications that are compatible with the apparatus 50, without requiring previous use to confirm compatibility. Thus, the application recommendation may include one or more applications that are both relevant to the user's interests (by basing the application recommendation off of the user behavior model), and compatible with the apparatus 50 (by basing the application recommendation off of the device characteristics). Further, the device characteristics and user behavior model may be continuously or periodically updated by the above-discussed modules so as ensure that application recommendations are current in terms of the device compatibility (as indicated by the device characteristics) and the user's preferences (as indicated by the user behavior model).

Once the recommendation module 84 issues an application recommendation, the user may then install one or more applications. For example, the recommendation module 84 may provide the user with a web services interface or plug-ins or gateway services enabling installation of the application(s). In some embodiments a direct link to one of the content providers 35 may be provided. Further, in some embodiments the recommendation module 84 may include a mobile payment service interface in order to allow the user to pay for applications as required. However, installation of the applications may occur via a separate application installer module in other embodiments.

In some embodiments the apparatus 50 may further include a query module 86. The processor 70 or other circuitry may be embodied as, include or otherwise control the query module 86. In some embodiments, as described above, the recommendation module 84 may directly consult the user behavior model for an application name or other identifier and then search for related applications when causing an application recommendation to issue. However, in other embodiments the recommendation module 84 may provide the query module 86 with the names (or other identifiers) of one or more applications (and in some embodiments characteristics thereof) that have been used under circumstances that are similar to the current contextual characteristics. Then the query module 86 may map the identifier(s) of the application(s) to application profile information associated therewith. Thereby, the query module 86 may query for available applications that have similar or matching application profile information. For example, the query module 86 may issue the query to the content provider registrar 40, or an internal module that performs the same or a similar function, as will be discussed below. The query module 86 may format the query using terminology based on an ontology model. Thus, in some embodiments the recommendation module 84 may issue the recommendation based on information provided by the query module 86 in response to the query.

By way of example, if the user frequently uses a news application when he returns home from work in the evening, this may be reflected in the user behavior model. Thereby, the recommendation module 84 may provide the name of the news application (and/or other information relating thereto) to the query module 86 and then, for example, the query module may provide the recommendation module with a list of news applications recommended for the user when the characteristic determiner 80 determines that the user is at home during the evening.

Alternatively, the recommendation module 84 may provide the query module 86 with a type or category of application, and the query module may then query for available applications in the category. For example, if the recommendation module 84 determines from the user behavior model that an application in the category of news has been used under similar contextual characteristics, the query module 86 may select an application in this category from available applications. The selection of applications by the query module 86 may be based on application profile information associated with the applications, which may be provided by a content provider registrar 40, or an internal module performing the same or similar functions, as will be discussed below.

By way of further example, the recommendation module 84 may provide the query module 86 with a type or category of content for output and/or a function to be performed by an application in embodiments in which the monitoring module 78 monitors user interactions within applications. In such embodiments after the recommendation module 84 provides the query module 86 with a content category or function, the query module may select an application from the available applications based on application profile data associated therewith. For example, the application profile data may indicate categories of content which are outputted as well as functions performed by the applications in some embodiments.

Note that since the user behavior model may be privately stored (e.g., in the memory device 76), and the recommendation module 84 and query module 86 may be embodied on the apparatus 50, user information may be maintained in privacy. Thereby, relatively greater control may be maintained over information relating to user preferences and activities. For example, exporting of user interaction data and associated contextual characteristics to external servers may not be required. Further, the user behavior model may be relatively more accurate than other models because the data on which the user behavior model is based may be particular to the user. Additionally, the device characteristic information may be stored on the apparatus 50 (e.g., in the memory device 76). Thereby, the device characteristics may also be privately stored in some embodiments.

As a further note, the query, the recommendation, the application profile data, the contextual characteristics, and other information and data processed or otherwise employed by the apparatus 50 may be formatted to fit an ontology model. In this regard, for example, the application recommendation from the recommendation module 84 may search for and recommend applications from a category of applications, such as “sports news” which may be a term from the ontology model. The application profile data may be formatted using the same ontology model such that any applications relating to this category may be identified based on the terminology within the ontology model. Thus, by standardizing the terminology employed by the various modules of the apparatus 50, recommendations may be improved so as to identify relevant applications, content, and/or functions. Further, the ontology model may be updated continuously or periodically so as to account for new types of content, context, and applications.

As indicated above, the recommendation module 84 may cause the application recommendation to issue in the form of one or more recommended applications. In this regard, in some embodiments the apparatus 50 may further include a registrar module 88. The processor 70 or other circuitry may be embodied as, include or otherwise control the registrar module 88. The registrar module 88 may be configured to control registration of the content providers 35 from which the one or more applications are selected for use by the apparatus 50 and store or otherwise provide access to application profile information associated therewith. Thus, in some embodiments the registrar module 88 may selectively allow or disallow the content providers 35 from providing applications to the apparatus 50 by allowing or disallowing registration of the content providers as potential application sources. Accordingly, the registrar module 88 may in some embodiments perform the same or similar functions, as are performed by the content provider registrar 40. Hence, the registrar module 88 may be provided in embodiments of the apparatus 50 that do not operate in conjunction with the content provider registrar 40, or vice versa.

In embodiments employing the content provider registrar 40, greater control may be maintained over the applications that are selected for the application recommendations. In this regard, the content provider registrar 40 may centrally control registration of the content providers 35 from which the one or more applications are selected. Thereby, all devices (e.g., user terminals 10 embodying the apparatus 50) operating in conjunction with the content provider registrar 40 to receive application recommendations may be restricted to recommendations of applications supplied by the registered content providers 35.

Conversely, dispersed use of the registrar module 88 on each device (e.g., user terminals 10 embodying the apparatus 50), instead of centralized use of the content provider registrar 40, may impart the user of each device with greater control over the source of the applications that are recommended in some embodiments. For example, the registrar module 88 may allow the user to control registration of the content providers 35 from which the one or more applications are selected for the application recommendations. Further, in some embodiments the registrar module 88 may be preconfigured with registered content providers 35, and then the user may add to or otherwise modify the registered content providers.

Thus, application recommendations may recommend applications supplied by one or more content providers 35. In some embodiments a single content provider 35 may be registered and hence all recommended applications may be supplied therefrom. For example, the application recommendation may only include applications from a single application store in some embodiments. However, in order to provide a greater variety of applications to the user of the apparatus 50, in other embodiments causing the application recommendation to issue may comprise selecting one or more applications supplied by a plurality of content providers 35. Thereby, a variety of content providers 35 may be employed to supply applications for application recommendations in embodiments in which multiple content providers are registered.

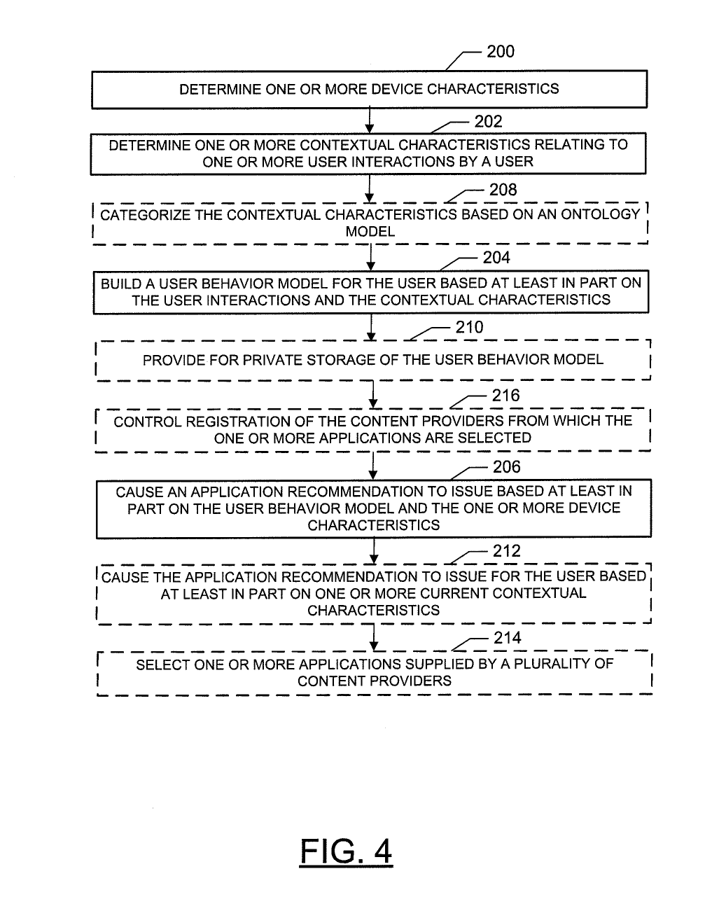

In terms of methods associated with embodiments of the present invention, the above-described apparatus 50 or other embodiments of apparatuses may be employed. In this regard, FIG. 4 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method may include determining one or more device characteristics at operation 200. Device characteristics may comprise at least one of a hardware indicator and a software indicator in some embodiments. Further, the method may include determining one or more contextual characteristics relating to one or more user interactions by a user at operation 202. Also, the method may include building a user behavior model for the user based at least in part on the user interactions and the contextual characteristics at operation 204. The method may further include causing an application recommendation to issue for the user based at least in part on the user behavior model and the one or more device characteristics at operation 206.

In some embodiments, certain ones of the above-described operations (as illustrated in solid lines in FIG. 4) may be modified or further amplified. In some embodiments additional operations may also be included (some examples of which are shown in dashed lines in FIG. 4). It should be appreciated that each of the modifications, optional additions or amplifications may be included with the above-described operations (200-206) either alone or in combination with any others among the features described herein. As such, each of the other operations as will be described herein may be combinable with the above-described operations (200-206) either alone or with one, more than one, or all of the additional operations in any combination.

For example, the method may also include categorizing the contextual characteristics based on an ontology model at operation 208. Further, the method may include providing for private storage of the user behavior model at operation 210. Additionally, the operation 206 of causing the application recommendation to issue may comprise causing the application recommendation to issue based at least in part on one or more current contextual characteristics at operation 212. In some embodiments issuing the application at operation 206 may additionally or alternatively comprise selecting one or more applications supplied by a plurality of content providers at operation 214. Further, as illustrated at operation 216, the method may include controlling registration of the content providers from which the one or more applications are selected.

In an example embodiment, an apparatus for performing the method of FIG. 4 and other methods described above may comprise a processor (for example, the processor 70) configured to perform some or each of the operations (200-216) described above. The processor may, for example, be configured to perform the operations (200-216) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-216 may comprise, for example, the processor 70, the user interface 72, the communication interface 74, the monitoring module 78, the characteristic determiner 80, the data model builder 82, the recommendation module 84, the query module 86, and the registrar module 88, as described above. However, the above-described portions of the apparatus 50 as they relate to the operations of the method illustrated in FIG. 4 are merely examples, and it should be understood that various other embodiments may be possible.

In some embodiments the operation 200 of determining one or more device characteristics may be conducted by means, such as the characteristic determiner 80 and/or the processor 70. Additionally, the operation 202 of determining one or more contextual characteristics relating to one or more user interactions by a user may be conducted by means, such as the user interface 72, the monitoring module 78, the characteristic determiner 80, and/or the processor 70. Also, the operation 204 of building a user behavior model for the user based at least in part on the user interactions and the contextual characteristics may be conducted by means, such as the monitoring module 78, the characteristic determiner 80, the data model builder 82, and/or the processor 70. Additionally, the operation 206 of causing an application recommendation to issue for the user based at least in part on the user behavior model and the one or more device characteristics may be conducted by means, such as the data model builder 82, the recommendation module 84, the query module 86, and/or the processor 70.

Also, the operation 208 of categorizing the contextual characteristics relating to the user interactions may be conducted by means, such as the monitoring module 78, the characteristic determiner 80, the data model builder 82, and/or the processor 70. Additionally, the operation 210 of providing for private storage of the user behavior model may be conducted by means, such as the data model builder 82, the memory device 76, and/or the processor 70. Further, the operation 212 of causing the application recommendation to issue for the user based at least in part on one or more current contextual characteristics may be conducted by means, such as the characteristic determiner 80, the recommendation module 84, the query module 86, and/or the processor 70. Also, the operation 214 of selecting one or more applications supplied by a plurality of content providers may be conducted by means, such as the data model builder 82, the recommendation module 84, the query module 86, the registrar module 88, and/or the processor 70. Further, the operation 216 of controlling registration of the content providers from which the one or more applications are selected may be conducted by means, such as the registrar module 88, and/or the processor 70.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to:
determine one or more device characteristics;
determine one or more contextual characteristics relating to one or more user interactions by a user;
build a user behavior model for the user based at least in part on the user interactions and the contextual characteristics; and
cause an application recommendation to issue for the user based at least in part on the user behavior model and the one or more device characteristics.

2. The apparatus of claim 1, further configured to cause the application recommendation to issue based at least in part on one or more current contextual characteristics.

3. The apparatus of claim 1, wherein the one or more device characteristics comprise at least one of a hardware indicator and a software indicator.

4. The apparatus of claim 1, further configured to provide for private storage of the user behavior model.

5. The apparatus of claim 1, further configured to select one or more applications supplied by a plurality of content providers.

6. The apparatus of claim 5, further configured to control registration of the content providers from which the one or more applications are selected.

7. The apparatus of claim 1, further comprising user interface circuitry configured to:
facilitate user control of at least some functions of the apparatus through use of a display; and
cause at least a portion of a user interface of the apparatus to be displayed on the display to facilitate user control of at least some functions of the apparatus.

8. A method, comprising:
determining one or more device characteristics;
determining one or more contextual characteristics via a processor relating to one or more user interactions by a user;
building a user behavior model for the user based at least in part on the user interactions and the contextual characteristics; and
causing an application recommendation to issue for the user based at least in part on the user behavior model and the one or more device characteristics.

9. The method of claim 8, further comprising causing the application recommendation to issue based at least in part on one or more current contextual characteristics.

10. The method of claim 8, wherein the one or more device characteristics comprise at least one of a hardware indicator and a software indicator.

11. The method of claim 8, further comprising categorizing the contextual characteristics based on an ontology model.

12. The method of claim 8, further comprising providing for private storage of the user behavior model.

13. The method of claim 8, further comprising selecting one or more applications supplied by a plurality of content providers.

14. The method of claim 13, further comprising controlling registration of the content providers from which the one or more applications are selected.

15. A computer program product comprising at least one computer-readable storage medium having computer-executable program code portions stored therein, the computer-executable program code portions comprising:
program code instructions for determining one or more device characteristics;
program code instructions for determining one or more contextual characteristics relating to one or more user interactions by a user;
program code instructions for building a user behavior model for the user based at least in part on the user interactions and the contextual characteristics; and
program code instructions for causing an application recommendation to issue for the user based at least in part on the user behavior model and the one or more device characteristics.

16. The computer program product of claim 15, further comprising program code instructions for causing the application recommendation to issue based at least in part on one or more current contextual characteristics.

17. The computer program product of claim 15, wherein the one or more device characteristics comprise at least one of a hardware indicator and a software indicator.

18. The computer program product of claim 15, further comprising program code instructions providing for private storage of the user behavior model.

19. The computer program product of claim 15, further comprising program code instructions for selecting one or more applications supplied by a plurality of content providers.

20. The computer program product of claim 19, further comprising program code instructions for controlling registration of the content providers from which the one or more applications are selected.
